(19) United States
(12) Patent Application Publication
(10) Pub. No.: US 2004/0020101 A1
(43) Pub. Date: Feb. 5, 2004

(54) Fishing lure and spinner blade

(76) Inventor: Gene Paul Northrop, Union Hall, VA (US)

Correspondence Address: RODNEY A. CORL, 2338 CATAWBA RD., TROUTVILLE, VA, 24175, US

(21) Appl. No.: 10/632,381

(22) Filed: Aug. 1, 2003

Related U.S. Application Data
(63) Continuation-in-part of application No. 10/208,988, filed on Aug. 1, 2002, now abandoned.

(51) Int. Cl. A01K 85/00

(52) U.S. Cl. 43/42.13

(57) ABSTRACT

A fishing lure is described which has a body resembling a fish of prey, and having two spinners attached to the body and extending forwardly from the body, such that the lure resembles a fish chasing after a prey of its own. Predator fish are known to take advantage of another fish being distracted while preying on a fish or insect, and striking during this distraction. The spinners that are attached to the body must be very efficient and low drag for the lure to operate properly. Each spinner has a rectangular planar body with a center axis, and portions extending to either side of the center axis. The portions to either side have leading and trailing portions which are alternately bent upwardly and downwardly. These upwardly and downwardly bent portions are bent a constant amount across the leading and trailing edges, creating more spinning action for a constant drag, or a lower drag for a constant spinning action. As the spinner is drawn through the water, the alternately bent portions cause the spinner to rotate about the center axis. The lure with the attached spinners has the advantage of having less drag as it is drawn through the water than similar lures of the prior art. A diving lip can be added to the lure body to make it a diving crank bait.

### CROSS REFERENCE TO RELATED APPLICATIONS

This application is a continuation-in-part of application Ser. No. 10/208,988 filed Aug. 1, 2002, now abandoned.

### BACKGROUND OF THE INVENTION

This invention relates generally to fishing lures, and more particularly to a lure having a spinner with improved spinning action. The spinner of the present invention has the advantage of having the desired spinning action of current spinning lures but with the advantages of lower drag, ease of manufacture, and improved effectiveness in attracting fish.

The fishing lure of the present invention is designed to attract any predatory fish. The main body of the lure is of a shape and size as to represent many kinds of prey. The size and shape of the main body is consistent with many lures already in existence. The present invention adds wires with spinners attached thereto, attached to the main body on each side thereof and extending out in front of the main body. The spinners add flash and slight vibration to represent smaller prey fleeing ahead of the main lure body. Most predatory fish will ambush a prey that is distracted while chasing prey of its own.

There are many prior attempts at making a spinning lure which is effective at attracting fish as well as efficient to manufacture and easy to use. An early attempt is by Pratt, U.S. Pat. No. 2,935,809. Pratt shows a lure with a body having a spinning vane extending from the body which spins as the lure is pulled through the water. The spinning vane of Pratt is in the form of a rotor type vane. The disadvantage of Pratt is that a torque is developed by the spinning vane which is not counter-balanced, making the lure unstable as it is pulled through the water.

U.S. Pat. No. 2,306,640 to Nelson shows a spinner of a type similar to the spinner of the present invention, having opposed upwardly and downwardly turned leading and trailing edges. However, the spinners of the present invention are more efficient than those of Nelson, creating more spinning action with equal drag, or having less drag with equal spinning action, due to the special design of the leading and trailing edges of the spinner blade. Nelson does not show the arrangement of the spinners in front of a lure body as in the present invention.

Another attempt at making a fish attracting spinning lure is by Long, et al., U.S. Pat. No. 4,793,089. In the patent to Long, et al., nested vanes are mounted on a portion of the lure to spin at different speeds thus hitting against each other and making a fish attracting noise. The vanes of Long, et al. are of a type which create a high drag which put an increased drag on the lure as it is retrieved through the water. This is an undesirable effect for a lure to have.

Hay, U.S. Pat. No. 6,044,583, shows an improved spinner for a fishing lure which is lightweight, is easy to manufacture, and has a decreased drag over prior spinner type lures. While the spinner to Hay is an improvement over the prior art spinners, the spinner of the present invention is an improvement over Hay, having an even lower drag than Hay as well as ease of manufacture and is light weight. Further, the arrangement of the spinners on the lure of the present invention provides a lure which is easy to retrieve through the water and has an increased attractiveness to fish.

U.S. Pat. Nos. 2,167,945 to Gilliam and 5,911,570 to Freitas, et al. show lures having a main body with spinners attached to wires and extending generally at a right angle outwardly from the body. While these lures create quite a disturbance as they are drawn through the water, they don't create the realistic display of a predator chasing after a prey.

### BRIEF SUMMARY OF THE INVENTION

The present invention provides an improved lure and a spinner for a lure which can be used on existing spinning lures and which is lightweight, is easy to manufacture, has a very low drag as it is retrieved through the water, and most importantly provides a spinning action which is very attractive to fish. The spinner of the present invention can be used on spinner baits for almost any type of fresh water fishing including trout, bass, perch, pickerel, catfish, and also for many salt water species. The spinner can be made very small for attracting the smaller panfish species, or can be made very large for attracting large salt-water species of fish, or anywhere in between.

The spinner of the present invention can be made from aluminum, brass or plastic. Aluminum has the advantages of being light weight and it is easily formed into the desired shape. Brass is readily solderable and can have parts affixed thereto by soldering. Plastic is most desirable do to its ease of manufacturing as parts can readily be molded to the final desired form.

The spinner of the present invention has a design which makes it have a very low drag as it is retrieved through the water. This feature will be appreciated by an angler who makes hundreds of casts and retrieves in a single day of fishing. Further, the spinning action of the present spinner is very attractive to fish resulting in more hits on a lure making use of the present invention.

A fishing lure which makes use of two of the spinners of the present invention is also described. The fishing lure comprises a main body, which represents any fish of prey, having two wires extending forwardly from the body with a spinner of the present invention attached to each wire. The lure represents a fish of prey chasing after its own prey.

It therefore is an object of the present invention to provide an improved spinner for a fishing lure. It is an object of the present invention to provide a spinner that is easy to manufacture. It is a further object of the present invention to provide a spinner that is lightweight and which has a very low drag as the spinner is retrieved through the water. It is another object of the present invention to provide a lure that is very attractive to many species of fish. It is a final object of the present invention to provide a lure which incorporates the spinner of the present invention in a unique configuration, to represent a fish of prey chasing after its own prey.

These and other objects will become more apparent in view of the accompanying drawings and detailed description.

### BRIEF DESCRIPTION OF THE DRAWINGS

The invention will be further described in connection with the accompanying drawings, in which:

FIG. 1 is a plan view of a lure incorporating the spinners of the present invention;

FIG. 2 is a side view of the lure of FIG. 1;

FIG. 3 is a perspective view of one embodiment of a spinner of the present invention;

FIG. 4 is a front view of the spinner shown in FIG. 3;

FIG. 5 is a top view of the spinner shown in FIG. 3;

FIG. 6 is a perspective view of a second embodiment of a spinner of the present invention;

FIG. 7 is a front view of the spinner shown in FIG. 6;

FIG. 8 is a top view of the spinner shown in FIG. 6;

FIG. 9 is a perspective view of a third embodiment of a spinner of the present invention;

FIG. 10 is a front view of the spinner shown in FIG. 9; and

FIG. 11 is a top view of the spinner shown in FIG. 9.

### DETAILED DESCRIPTION

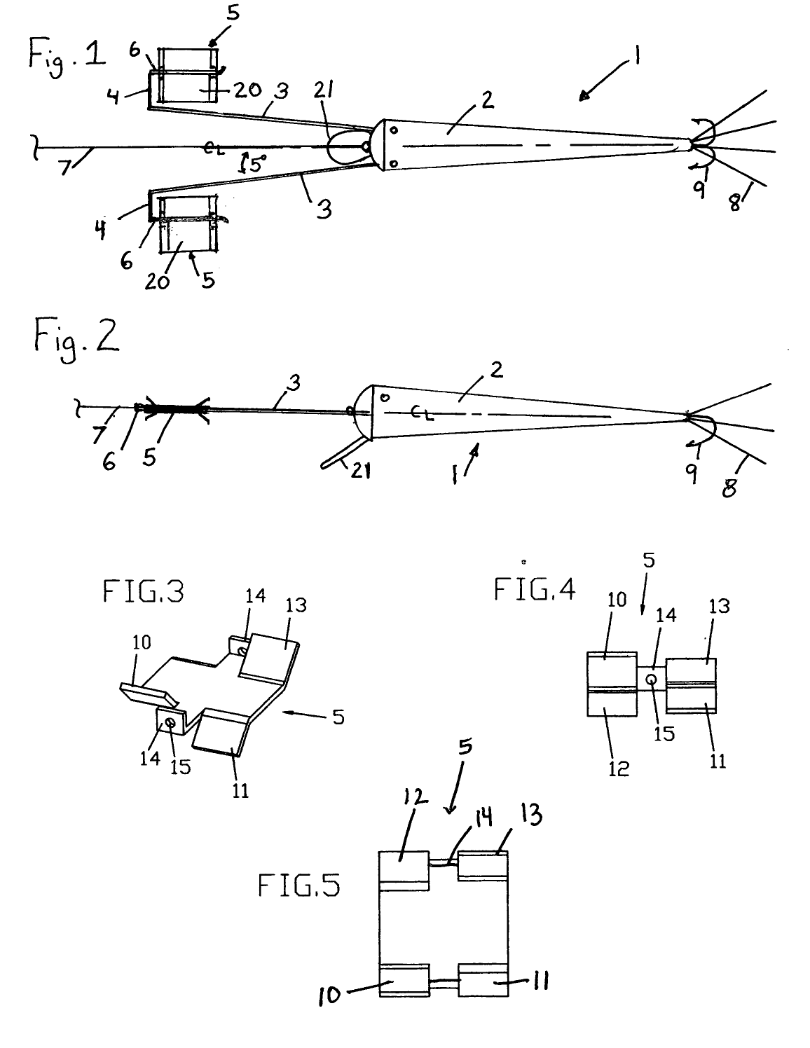

Referring to FIGS. 1 and 2, a preferred embodiment of a fishing lure 1 is shown which makes use of the spinners 5 of the present invention. The lure 1 has a main body 2 of conventional fishing lure construction. The body may be made of any lightweight material such as wood, balsa, or plastic. Attached to body 2 are from one to three hooks 9, depending on the size of the lure, extending from the rear of the body or alternatively the hooks may extend from the underside of the body or a combination of from the rear and underside. The hooks may be attached to eyes molded into the body, as is known. A skirt 8 may be attached to the body 2 and surround hooks 9 to disguise the hooks. The lure body 2 is attached to a fishing line 7 as is known. The body and hook arrangement of the lure is formed to resemble a fish of prey that is preyed upon by the species for which the angler is fishing. For a surface running style lure, two stiff wires 3 are integrally molded into the lure body 2 such that they cannot change their alignment. Wires 3 are preferably made of titanium, or alternatively of spring steel. Wires 3 extend forwardly of lure body 2 and slightly outwardly such that the wires 3 and the longitudinal centerline of lure body 2 make an angle with each other of about 5 degrees. At a forward portion of wire 3, the wires are bent at an angle outwardly a distance of about one-half the width of spinner 5 to form an extension portion 4 which is generally perpendicular to the body centerline. There, the wires are bent once again to form a spinner mounting extension 6 extending rearwardly generally parallel to the centerline. Spinners 5 are rotatably attached to the extensions 6 and rotate about the axis of the extension 6. The spinners 5 are mounted so that they rotate about extension 6 at a distance which puts them well in front of the lure body 2. This arrangement of spinners extending from the body and rotating about an axis parallel to the longitudinal axis of the body provides a spinner lure which is stable as it is retrieved through the water. This arrangement also provides a lure with less drag when compared to lures of similar types without this spinner arrangement. Further, this arrangement of lure body and two spinners attached on wire extensions in front of the body creates a disturbance in the water as the lure is retrieved through the water which resembles a fish chasing after a prey, which is especially attractive to other predatory fish, resulting in more fish strikes than with the prior art spinner lures.

The addition of a diving lip 21 to the lure body 2 will change the lure from a surface running lure to a diving crank bait. For this type of lure to work properly, the spinners must be of very low water resistance. Otherwise, when the lure is retrieved through the water, the drag will cause it to rise to the surface. A very low drag spinner, which is necessary for the proper operation of the lure, is hereafter described.

As can be seen in FIG. 1, the spinner 5 of the present invention is comprised of a body 20 which is generally rectangular in shape. This body 20 can be cut from a thin sheet of aluminum into the rectangular shape shown. As seen more clearly in FIGS. 3-5, tabs 14 can be cut from the middle of each side of the rectangular body and bent upwardly and provided with a hole 15 therethrough. The extensions 6 of thin wire extend through the holes 14 and provide an axis about which the spinner 5 rotates. On one side of the tabs 14, a leading edge 10 is bent upwardly and a trailing edge 12 is bent downwardly so as to provide a rotational force to spinner 5 as water flows thereover as the spinner attached to a lure is drawn through the water. On the opposite side of the tabs 14 a similar arrangement is provided except that on this side, the leading edge 11 is bent downwardly and the trailing edge 13 is bent upwardly in opposition to the directions on the opposite side. This effectively doubles the rotational force imparted to spinner 5 about the axis of wire extension 6. While this embodiment of the spinner 5 has been described as being made from aluminum sheet, it is to be understood that the same arrangement can be made from plastics molded to the desired shape.

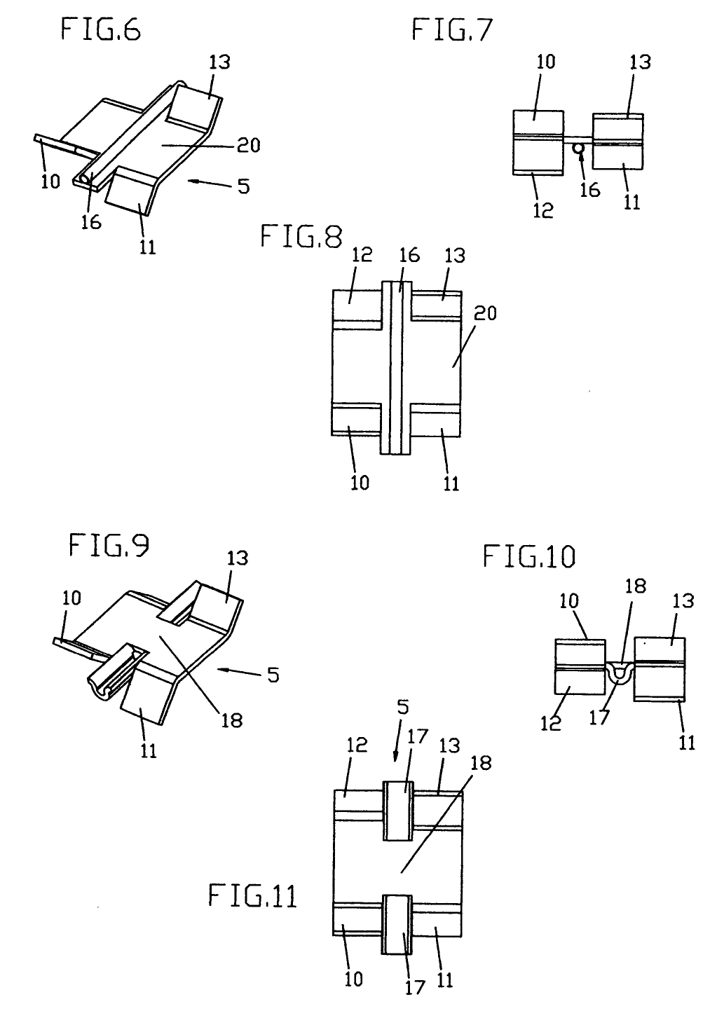

A second embodiment is shown in FIGS. 6-8. In this embodiment, the spinner body 5 has the same general arrangement of leading edge 10 and trailing edge 13 being turned up, and leading edge 11 and trailing edge 12 being turned down to effect the rotational force of the spinner about the axis of the wire extension 6. The spinner body 20 in FIGS. 6-8 may be made of brass, in which case a piece of brass tubing 16 may be soldered to the body. The wire extension 6 extends through tubing 16 and spinner 5 rotates thereabout. Alternately, the body 20 may be made of other materials such as plastic or aluminum, and a piece of tubing 20 may be glued to the body.

A third embodiment is shown in FIGS. 9-11 wherein the spinner is formed from a single piece of aluminum or other metal. In this embodiment, the upwardly and downwardly turning leading and trailing edges 10, 11, 12 and 13 can be formed by stamping of the metal piece in a die and press. The portion through which the wire extension 6 extends can be formed in the same stamping action by pressing sections 17 downwardly. A small slit is formed at each end of the center section 18 to allow the sections 17 to be formed downwardly away from center section 18, creating a channel through which extensions 6 extend.

While a preferred form of the invention has been shown in the drawings and described in the preceding paragraphs, variations of the preferred form will be apparent to those skilled in the art, and the invention should not be construed as limited to the specific form shown and described, but instead is as set forth in the following claims.

I claim:

1) A fishing lure which resembles a fish of prey chasing after its own prey as it is drawn through water, comprising:
a body having a longitudinally extending axis and at least one hook attached to said body,
a first wire, integrally molded with said body, extending forwardly from said body and extending outwardly at a small angle to said longitudinally extending axis, said first wire extending for a first distance, said first wire being bent at the culmination of said first distance at an angle to extend perpendicular to said longitudinally extending axis to extend for a second distance, said first wire being bent at the culmination of said second distance at a right angle to extend rearwardly parallel to said longitudinally extending axis and to extend for a third distance, a first spinner rotatably attached to said first wire along said third distance,
a second wire, integrally molded with said body, extending forwardly from said body and extending outwardly at a small angle to said longitudinally extending axis in a direction opposite said first wire, said second wire extending for a fourth distance, said second wire being bent at the culmination of said fourth distance at an angle to extend perpendicular to said longitudinally extending axis to extend for a fifth distance, said second wire being bent at the culmination of said fifth distance at a right angle to extend rearwardly parallel to said longitudinally extending axis and to extend for a sixth distance, a second spinner rotatably attached to said second wire along said sixth distance,
wherein said first and second spinners are positioned entirely in front of said body so that as the lure is drawn through the water the body resembles a fish chasing after prey.

2) The fishing lure of claim 1 wherein said first spinner and said second spinner each comprise a spinner body of generally rectangular planar shape, each said spinner body having a spinner axis about which said spinner is caused to rotate, said spinner axis extending longitudinally along a center line of said spinner body, said spinner body having a left half extending to one side of said center line, said spinner body having a right half extending to another side of said center line, said left half having a leading edge portion and a trailing edge portion, said right half having a leading edge portion and a trailing edge portion, said leading edge portion of said left half and said trailing edge portion of said right half being turned downwardly, said leading edge portion of said right half and said trailing edge portion of said left half being turned upwardly, said upwardly turned portions and said downwardly turned portions are turned upwardly and downwardly respectively a constant amount across said leading edge portions and said trailing edge portions, wherein said first spinner is caused to rotate about said first wire and said second spinner is caused to rotate about said second wire in a low drag, efficient manner as said fishing lure is drawn through water.

3) The fishing lure of claim 1 wherein said small angle is about 5 degrees.

4) The fishing lure of claim 2 wherein said small angle is about 5 degrees.

5) The fishing lure of claim 1 wherein said first wire and said second wire are made of titanium.

6) The fishing lure of claim 2 wherein said first wire and said second wire are made of titanium.

7) The fishing lure of claim 1 wherein said first wire and said second wire are made of spring steel.

8) The fishing lure of claim 2 wherein said first wire and said second wire are made of spring steel.

9) The fishing lure of claim 1 wherein said body further comprises a diving lip attached at a forward portion of said body.

10) The fishing lure of claim 2 wherein said body further comprises a diving lip attached at a forward portion of said body.

11) A fishing lure which is to be drawn through water, having a spinner attached thereto, said spinner comprising:
a body of generally rectangular planar shape, said body having an axis about which said spinner is caused to rotate, said axis extending longitudinally along a center line of said body, said body having a left half extending to one side of said center line, said body having a right half extending to another side of said center line, said left half having a leading edge portion and a trailing edge portion, said right half having a leading edge portion and a trailing edge portion, said leading edge portion of said left half and said trailing edge portion of said right half being turned downwardly, said leading edge portion of said right half and said trailing edge portion of said left half being turned upwardly, said upwardly turned portions and said downwardly turned portions are turned upwardly and downwardly respectively a constant amount across said leading edge portions and said trailing edge portions, wherein said upwardly turned portions and said downwardly turned portions cause a low drag, efficient rotating action of said spinner about said axis as said fishing lure is drawn through water.
